(19) United States
(12) Patent Application Publication
(10) Pub. No.: US 2009/0288890 A1
(43) Pub. Date: Nov. 26, 2009

(54) Very efficient and safe solar car

(76) Inventor: Benjamin David Freeman, Philadelphia, PA (US)

Correspondence Address: Kenneth Bower, 314 Ironstone Lane, Elverson, PA, 19520, US

(21) Appl. No.: 12/154,571

(22) Filed: May 23, 2008

(51) Int. Cl. B60L 8/00; B60L 9/00

(52) U.S. Cl. 180/2.2; 180/65.31

(57) ABSTRACT

A Solar Car that is safer and far more ecologically benign than any automobile on the road today. All of its solar panels would serve a secondary purpose besides providing power. As a thin vehicle whose chasis was no wider than forty five inches, it would need an electrical system less than ninety seven volts. Connected in series, the four or five solar panels contemplated in this patent would provide most of the power. To make sure that one could use their vehicle regularly, there would also be a supplemental plug in capacity.

### BACKGROUND OF THE INVENTION

Due to the many traffic related fatalities and injuries, safety is of paramount importance in designing cars and other vehicles. However, the coming oil crisis and global warming make it even more important to create a car that will not be powered by fossil fuels. Since most people cannot afford to pay any more for cars than they are currently paying, we must find a way to improve safety and reduce the use of fossil fuels without increasing the cost of a car. Not only does this invention use solar panels to generate power and avoid the use of fossil fuels, but it integrates the solar panels into the design in such a way that they replace other car parts and improve the safety of the vehicle.

Despite the fact that side impacts are a major source of traffic fatalities, there has been no attempt found by this inventor (either in the patent art or in publicized prototypes or test vehicles) to create the type of side impact zone that could radically reduce the speed of impact before the incoming car actually hits. By comparison, there has been much work on improving bumpers in such a way that the power of a frontal impact would be reduced (see for instance U.S. Pat. No. 4,148,505). A fundamental reason that cars have better front impact zones than side impact zones is that there is a width restriction created by the width of a typical lane on roads and highways. While one can put a twenty inch barrier between the front of a car and the driver and riders, it is impossible to do this on the side of a typically sized car because the car would become too wide to ride in one lane. But, of course, one could start with a thinner car that could only seat one person per row rather than the typical two or three person rows in most cars. Since most car trips only involve one or two people, a two or three person “thin” car based on two or three rows could fulfill most people's driving needs.

Although I actually thought of the idea of a thin car on my own, later research suggested that a reissued patent given to Desert (U.S. Pat. No. 31156) also focused on a very thin but long vehicle. However, he never made the additional suggestion to use the extra space left in ones lane for side solar panels or any other type of side impact zone. What the vehicle contemplated in this patent does is to put solar panels in the extra space created by using a very thin vehicle. Not only does this allow one to have more solar panel coverage than the footprint of the “car,” but it allows us to use those side solar panels as a side impact crumple zone that will make the riders able to survive moderate speed side impacts.

With this basic idea of solar panels extending beyond the traditional car footprint in mind, the main embodiment of this vehicle also uses both a front and rear panel to extend the area of solar panels beyond the “car.” These panels should be as large as practical to help create a total area of solar panels which is larger than the footprint of the “car.” In practice, this may mean that the part of the panels extend over air rather than car parts. While others also have suggested a solar panel roof, the vehicle contemplated in this invention has so much total panel space extending beyond the roof that the solar panel roof constitutes less than half the total area of solar panels.

It is worth noting that this invention uses the words “solar panels” and the words “solar radiation capturing devices” interchangeably. Because panels have been the typical form of solar radiation capturing devices, it may be more easily understandable to use the words “solar panels.” But there have been other types of systems devised to convert solar radiation into electricity. For instance, there is some work on a filmlike substance that could be “painted” on to a harder substance. Once this filmlike (or paintlike) substance is actually affixed to a harder surface, one could call the resulting combination a solar panel. On the other hand, it might be more appropriate to simply call this or other more exotic forms by a different name than solar panels. Whether one calls these more exotic forms “solar panels” or not, they perform the same function and end up being more similar than different vis a vis solar panels. As the old saying “if it looks like a duck and walks like a duck, then it is a duck” suggests, these more exotic ways to convert solar rays into electricity are de facto “solar panels.” Rather than quibbling over whether they should be called “solar panels,” however, my “claims’ section refers to “solar radiation capturing devices” to make it clear that this idea would work just as well if one used a more exotic mechanism to collect the solar power or if one used a more traditional panel.

Similarly, the number of “solar panels” suggested in this patent really refers to areas where solar radiation is collected on the vehicle. Even in traditional solar “panels” the actual differentiation point between one and many panels is somewhat arbitrary. This is because the type of device which is normally sold as a “panel” actually consists of a larger number of smaller “panels” wired together in series or in parallel. Hence, the reference in this patent to a car with four or five solar panels is actually a reference to four or five areas where solar power is collected.

By extending the solar panels beyond the area where the riders, cargo, motor, batteries and other related equipment sits, the type of vehicle contemplated in this patent can generate more electricity than would be possible if one limits the area covered by solar panels to the area above where the riders, cargo, motor, batteries and related equipment sits. Nonetheless, there is a limited amount of solar energy available. It is with this in mind that one should consider another key point of my patent.

Despite the limited amount of electricity generated by solar panels, those who build the majority of solar vehicles (basically the racing and contest community), generally work with the same higher voltage as most electric vehicle manufacturers (I am defining a high voltage motor somewhat arbitrarily as one that uses more than 100 volts). While these higher voltage motors are more efficient on a cost and weight basis for each horsepower generated, getting enough voltage from the panels that one can mount on a car requires higher cost high voltage panels. It also requires a battery array that includes many batteries. Primarily to save money and complexity, the proposed vehicle follows the road less traveled by using motor voltage systems under 100 volts. While these lower voltage motors might be slightly less efficient on a per pound basis, the savings in solar panels, batteries and complexity more than compensate. Furthermore, if one builds a very lightweight version of this vehicle (especially if one builds a one person commuter car that is not intended to go over 55 MPH), one can use a 48 volt motor with a limited amp draw. Since 48 volts with a limited amp draw is below the voltage and power level that could kill someone, this allows one to build a safer vehicle without shielding materials to protect the driver and/or riders from an accidental impact with the electrical system.

As compared to a plug in electric car, a key practical advantage of a solar electric car is that it can be more easily charged at a location away from ones home. If, for instance, a solar electric car is used to commute thirty miles to work, the batteries may only need to have thirty miles of charge. This is because they can be recharged by the sun while you are working. A plug in electric, on the other hand, needs sixty miles of charge so that it can also make the return trip on the same charge. If every day was sunny, this would mean that you might be able to halve the size of the battery array without sacrificing range if an electric car had a sufficiently powerful solar panel array. While the possibility of cloudy days makes this a little more problematical, the type of deep cycle batteries used in electric vehicles can only be discharged more than 60% on rare occasions without damaging the batteries. They should usually be discharged no more than forty percent. Returning to the example of a driver whose main use is a thirty mile commute, this driver could easily work with a battery array whose eighty percent discharge rate would allow him to go sixty miles. In this case, he would normally only discharge the batteries forty percent and save 80% discharges for the rare day when it is cloudy. A regular plug-in electric car, on the other hand, would ruin its batteries more quickly if they were discharged the full eighty percent on a daily basis. So, in practice, it is possible to radically reduce the battery size without sacrificing range if one includes solar panels in the design. Even if one can only reduce the battery array size by forty percent, the resulting savings due to the lower weight and lower total battery price will offset most of the cost and weight of the solar panel array. Of course, the solar panel array can also replace the roof and hood and provides a significant safety edge for the type of car contemplated in this patent. In effect, the cost of the solar panels is covered by the combined direct and indirect effect of all these savings. Hence, the reduced need to pay for plug in electricity is a bonus along with the social good of reduced use of fossil fuel generated electricity.

### SUMMARY OF THE INVENTION

What we are designing is a vehicle whose strongly built inner cab is surrounded by a solar panel on each side and by a solar panel occupying the area which is normally occupied by a front hood in a more traditional car. The roof of this cab will also be a fourth solar panel. There could also be a fifth solar panel in the rear. While riding the vehicle, the two solar panels on the sides of the inner cab will generally be between twelve and twenty four inches off the ground. This is done so that the bumper of a car that hits our car from the side would hit a side solar panel. However, solar panels placed this low will be shaded by the roof panel and, possibly, even by the front hood panel. This means that they will not produce much electricity when the car is being driven. But, in fact, most people only drive their cars a small percentage of the day. When the car is not being driven, a variety of either mechanical or motorized means will be used to either raise the side panels to the same height as the roof panel or lower the roof panel to the same height as the side panels. If there is a fifth rear panel, it will either be raised or lowered so that all the non-hood panels are at the same height. Furthermore, it should be possible to tilt the panels to maximize the solar energy that they collect. In general the best way to park the car is facing south away from any shade offered by tall trees or buildings. For a car parked in this position, the panels should be positioned in such a way that they create an angle of inclination equal to the latitude where the car is being used. As long as the car is faced south when it is parked, it doesn't matter if the hood panel is slightly lower than the other panels because all the panels will still get direct sunlight.

However, people don't (or can't) always face south when parking. Therefore, we are contemplated a solar panel positioning system which allows the panels to be tilted in whatever manner maximizes solar output depending on the topography and location of where it is parked at any given time.

Since a solar panel provides a better crumple zone than a normal hood, the front solar panel will also improve the ability of the driver to survive a front end collision. And if there is a fifth rear panel, the same applies to a rear ending of this car by another car. Although this car will be much lighter than most other cars, the net effect of this array of side, front and, possibly, rear crumple zones is that this car will be inherently safer than the average car.

To understand why solar panels can create the majority of electricity needed, one starts by assuming that the vehicle is designed to create a range of approximately sixty miles per day. With a coverage system larger than the footprint of the passenger and driver car plus the cargo area and the area needed for the motor, batteries and miscellaneous related equipment, (at least 6500 square inches and up to 12,000 square inches), the total solar out-put should be between 2600 and 7500 watts per day. No one is going to always drive the full sixty miles per day of possible usage every single day. The average user will probably drive about twelve to fifteen miles per day (this is about half of the average usage of full sized gas cars without the limitations of our car). With a nine horsepower motor (seven thousand watts), a 5000 watt solar panel output could theoretically provide all the power needed. Clouds, other output related problems, hill climbing which uses more electricity, other wastage related problems and weeks when the person wants to maximize their driving will actually cause the typical user to need some plug-in supplement. Nonetheless, the facts outlined above indicate that the average rider will get most of their electricity from the solar panels and only use the plug-in capacity as a supplement.

Of course, the facts outlined above assume the state of the art of solar panels that exists when this patent was first being contemplated. Due to the huge need for more efficient but lower cost panels and the direction of the research that is being done on solar energy production, one can logically assume that new types of reasonably priced solar power collection devices will exist within five or ten years. These and improved standard types of panels will significantly increase the amount of wattage which could be created on a per square foot basis. Similarly, much work is being done to create batteries that are safer, reasonably priced and store much more electricity per pound. If both solar panels and batteries become twice as efficient, one could use a 48 volt motor to power a car with a driver and two passengers at speeds up to sixty miles per hour with a range that can accommodate ninety percent or more of the trips people actually use their cars for.

### DESCRIPTION OF SEVERAL VIEWS OF DRAWINGS

FIG. 1 A side view of a one seat version of the vehicle when it is being driven.

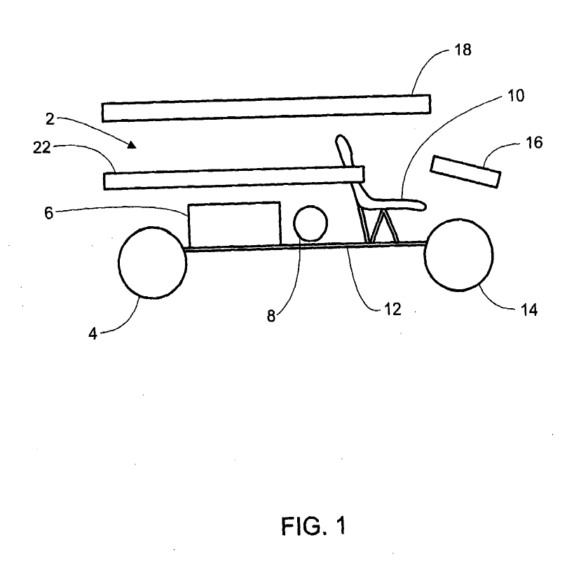

FIG. 2 One side view of a parked vehicle when the solar panel roof is lowered

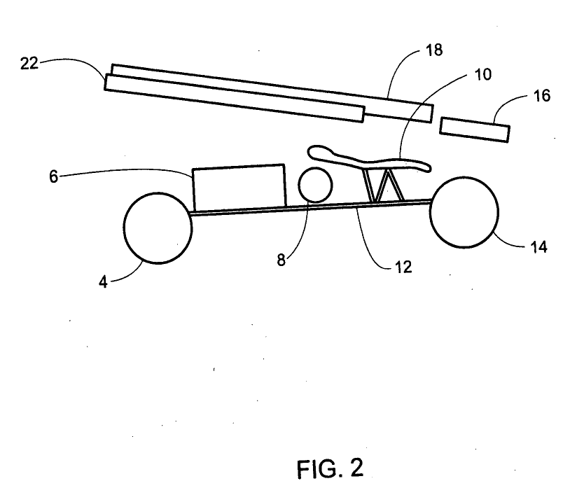

FIG. 3 A side view of a parked vehicle when the side panels are raised

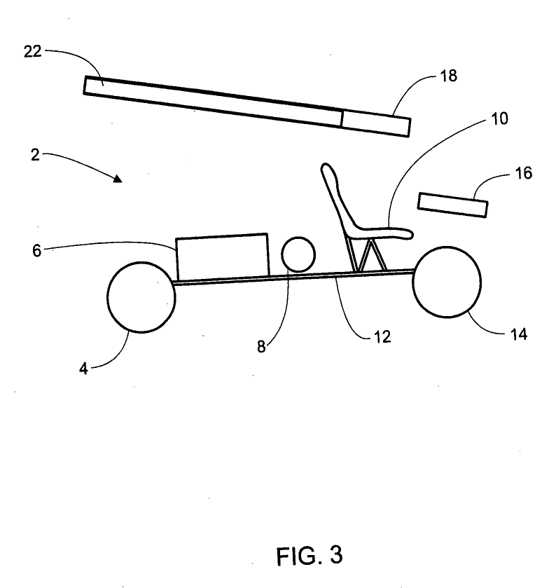

FIG. 4 Another side view of a vehicle being driven with a front and back seat.

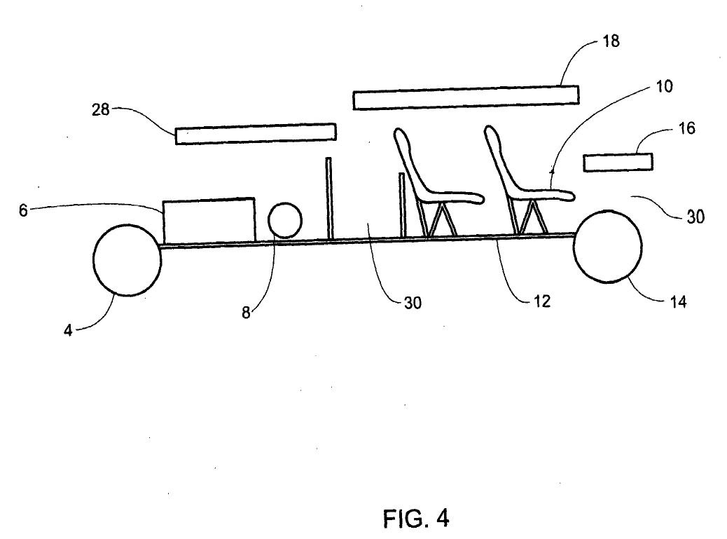

FIG. 5 a top view of the vehicle with four panels

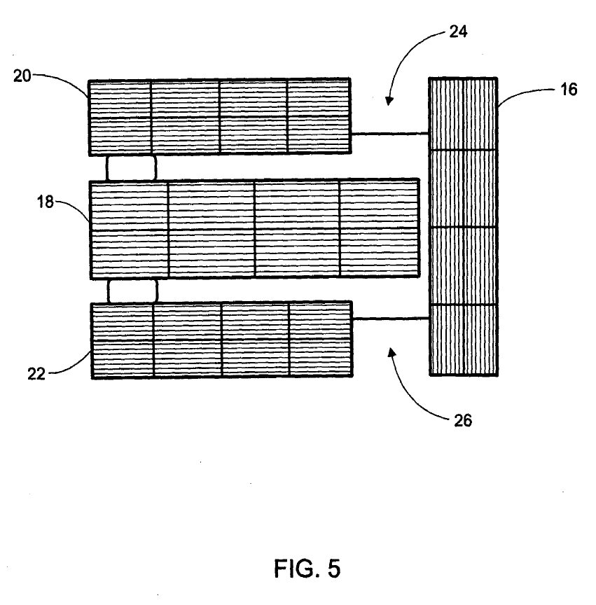

FIG. 6 a top view with an optional fifth panel included

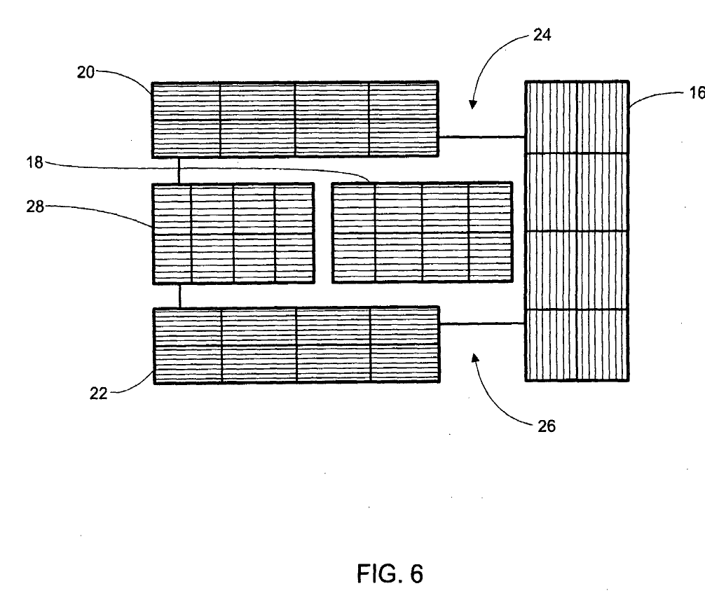

### DETAILED DESCRIPTION OF THE PRIMARY EMBODIMENT OF THE INVENTION REFERENCED TO DRAWINGS

Explanation of what the numbers mean on the drawings
2=room for lying passenger
4=back wheels
6=batteries
8=motor and controllers
10=driver seat
12=floor
14=front wheel
16=solar panel hood
18=solar panel roof
20=solar panel left side crumple zone
22=solar panel right side crumple zone
24=place to enter vehicle
26=egress for vehicle
28=optional rear solar panel
30=cargo area

The primary embodiment of the vehicle would have one front seat and a slightly wider rear bench. To maximize the size of the side solar panels, the vehicle would only have one point of egress on each side of the vehicle (while one could have only one point of egress on only one side of the vehicle, this would create a slight imbalance and make it more difficult to find an appropriate parking space). Partly because there is always a driver and partly because putting this point of egress in a position that would make it easier for the passenger to enter would break up the side solar panels, it makes more sense to put the point of egress in the front of the vehicle. This is best illustrated by figure six and numbers twenty four and twenty six.

While this twenty five inch wide inner cab would allow two adults to sit comfortably, it could also seat an extra small child in the slightly wider back bench. Giving the driver extra elbow room by making their seat less wide than the fill width of the inner cab gives the driver more maneuvering room for their arms and legs if needed while driving. Not having anyone sit in front with the driver also makes it easier for the driver to see in all directions without obstruction. Since the seat which can accommodate two people would be the one where there is no egress, these points also suggest that the point of egress should be in the front of the cab area. Hence, the front row would contain both the drivers' seat and a pathway for the back seat rider(s) to get into the back of the car. Above the inner cab where the driver and rider(s) sit would be the solar panel roof.

Behind the driver and riders would be a small cargo area. Behind that would be the batteries, motor and related equipment. Putting the small cargo area between the back seat and the motor and batteries would create a buffer zone in case an electrical problem occurred. There would also be a strong separation between the cargo area and the motor/batteries to provide further protection for the rider and driver from an electrical or battery problem. Above the cargo area and the batteries and motor would be a solar panel. Since the battery, motor and cargo area do not have to be as high as the top of a rider's head, the car could be driven with the rear solar panel lower than the roof panel. Figure four best illustrates these points.

The fundamental practical advantage of this very thin car is that it allows for more than twenty inches of side solar panels on each side of the vehicle without making the total vehicle so wide that it cannot fit into standard driving lanes.

Partly because most of the mechanical parts would be in the rear and partly because electric vehicles need less mechanical parts than gas driven cars, the front hood panel would mainly cover another cargo area, empty space, the front wheels and some area for wiring, front lights and supplemental material. Since most areas of the US are at least thirty degrees latitude north, the hood panel would be slanted to match that angle.

When the car was parked, the roof, side and rear panels could be moved mechanically to prevent any panel from shading any other panel and to maximize the amount of direct sunlight that hits the panels. While the optimal way that the panels would be positioned would partly depend on the exact topography and location of the parking spot being used, the general rule would be that the vehicle should be parked with the hood facing as close to due south as possible and in a place where none of the vehicle is shaded by trees, large buildings or other obstructions. When one measures the identical distance backward from the front of the car, a particular point on either side panel or the central panel(s) would be the same height from the ground. However, all of the panels would tilt at the same thirty degrees when viewing them from the side. In other words, all three panels might be forty five inches off the ground when measured just behind the hood panel while all three panels might be more than fifty inches off the ground when measured a few feet behind the hood panel. Although figures two and three represent a smaller one person car, the roof slant they suggest illustrates how this would work in practice.

While a person could theoretically position the panels properly on their own every time they park, the more advanced primary embodiment would combine mechanical panel movers with a computer driven positioning system to create the best slant for a given parking spot without the driver having to do it themselves.

I claim:

1. A new and improved vehicle adapted to capture solar radiation for the generation of power comprising:
a passenger compartment having one or more passenger egresses, one or more passenger supports, one or more openings allowing passengers to see outside of the vehicle and a roof separating the one or more passengers from a environment, one or more solar radiation capturing devices having a surface that is exposed to solar radiation, one or more energy storing devices for storing a power generated by the one or more solar radiation capturing devices,

2. The new and improved vehicle adapted to capture solar radiation for the generation of power of claim 1, wherein:
a total area of the one or more solar radiation capturing devices measured as projected on a roadway exceeds a combined area of a engine compartment, a passenger compartment, and a cargo area, measured as projected on the roadway,

3. The new and improved vehicle adapted to capture solar radiation for the generation of power of claim 1, wherein:
at least one of the solar radiation capturing devices is located directly above the area in front of the driver where a hood normally goes on a car.

4. The new and improved vehicle adapted to capture solar radiation for the generation of power of claim 1, wherein:
at least a first solar radiation capturing devices is oriented in an essentially upward facing direction and is located on a side of the passenger compartment,

5. The new and improved vehicle adapted to capture solar radiation for the generation of power of claim 3, wherein:
at least a first solar radiation capturing devices is contributory to the function of a crumple zone;

6. The new and improved vehicle adapted to capture solar radiation for the generation of power of claim 3, wherein:
the solar radiation capturing devices located on either side of the passenger compartment are located below the eye level of the passengers.

7. The new and improved vehicle adapted to capture solar radiation for the generation of power of claim 3, wherein:
one or more of the solar radiation capturing devices can be moved in an essentially vertical direction when the car is not being driven.

8. The new and improved vehicle adapted to capture solar radiation for the generation of power of claim 3, wherein:
the movement of some or all of the solar radiation capturing devices includes the possibility of tilting or non-vertical movement so that it is possible that none of the solar radiation capturing devices shade any other solar radiation capturing devices and that the amount of sunlight directly hitting the panels is optimized for any given parking location.

9. The new and improved vehicle adapted to capture solar radiation for the generation of power of claim 1, wherein:
a power output connections of at least two of the solar radiation capturing devices are connected in series,

10. The new and improved vehicle adapted to capture solar radiation for the generation of power of claim 1, wherein:
a power output connections of at least two of the one or more solar radiation capturing devices are connected in a manner where the combined output measures between 48 volts and 96 volts,

11. The new and improved vehicle adapted to capture solar radiation for the generation of power of claim 1, wherein:
one or more energy storing devices for storing the power generated by the one or more solar radiation capturing devices is alternatively chargeable from a source other than the solar radiation capturing devices,

12. The new and improved vehicle adapted to capture solar radiation for the generation of power of claim 1, wherein:
There is at least a third solar radiation capturing device that is oriented in an essentially upward facing direction and is located directly above the passengers compartment,

13. The new and improved vehicle adapted to capture solar radiation for the generation of power of claim 1, wherein:
There is at least a fourth solar radiation capturing devices located behind the passenger compartment and facing in an essentially upward facing direction,

14. The new and improved vehicle adapted to capture solar radiation for the generation of power of claim 12, wherein:
one or more solar radiation capturing devices located behind the passenger area can be raised or lowered when the car is at rest so that none of the solar radiation capturing devices shade any other radiation capturing device and that the amount of direct sunlight hitting the panels is optimized for a given location,

15. The new and improved vehicle adapted to capture solar radiation for the generation of power of claim 2, wherein:
At least a fourth solar radiation capturing devices located behind the passenger compartment and facing in an essentially upward facing direction,

16. The new and improved vehicle adapted to capture solar radiation for the generation of power of claim 15, wherein:
one or more solar radiation capturing devices located behind the passenger area can be raised or lowered when the car is at rest so that none of the solar radiation capturing devices shade any other radiation capturing device,

17. The new and improved vehicle adapted to capture solar radiation for the generation of power of claim 3, wherein:
A fourth solar radiation capturing devices located behind the passenger compartment and facing in an essentially upward facing direction,

18. The new and improved vehicle adapted to capture solar radiation for the generation of power of claim 17, wherein:
one or more solar radiation capturing devices located behind the passenger area can be raised or lowered when the car is at rest so that none of the solar radiation capturing devices shade any other radiation capturing device,

19. The new and improved vehicle adapted to capture solar radiation for the generation of power of claim 4, wherein:
a fourth solar radiation capturing devices located behind the passenger compartment and facing in an essentially upward facing direction,

20. The new and improved vehicle adapted to capture solar radiation for the generation of power of claim 19, wherein:
one or more solar radiation capturing devices located behind the passenger area can be raised or lowered when the car is at rest so that none of the solar radiation capturing devices shade any other radiation capturing device and so that direct sunlight on the solar panels is optimized for any given parking location.
